(19) United States
(12) Patent Application Publication
(10) Pub. No.: US 2006/0081096 A1
(43) Pub. Date: Apr. 20, 2006

(54) Tool and methodology for marking, routing, locating, and installing wiring and cable

(76) Inventor: Kim A. Sadberry, Missouri City, TX (US)

Correspondence Address: Kim A. Sadberry, 2918 Bull Run Ct., Missouri City, TX, 77459, US

(21) Appl. No.: 11/132,374

(22) Filed: Nov. 14, 2005

Related U.S. Application Data
(60) Provisional application No. 60/572,868, filed on May 20, 2004.

(51) Int. Cl. B25B 27/00

(52) U.S. Cl. 81/488

(57) ABSTRACT

The Kimrod is comprised of three major components: Polycarbonate tubing that varies in diametcr based on application Phosphorescent wire that comes in a variety of colors. Power supply that inverts direct current to alternating current.

### SPECIFICATION

The Kimrod is a state of the art wiring and cabling tool that allows one to quickly identify wiring points. This tool is flexible and durable. It is designed to give the user the advantage of quick location of wiring pulls and wiring drops in attics for residents, and dropped ceilings for commercial applications. This tool also allows the user to identify by specific colors each precise point to be wired or located.

The tool has many uses, such as; point location for electrical applications, Running of security system wiring is reduced to a fraction of the time normally taken to run and locate wires in the attic Telephone wiring through attics is also faster and safer. This tool will allow persons doing data cabling in dropped ceiling applications to locate wires from long distances easily and much faster. Because the Kimrod is housed in a polycarbonate Tube, it is flexible. This allows the user to bund the tool in situations where it is necessary to bend. The phosphorescent light emitted by the tool is located by a constant flashing of the internal wiring's illumination. The Kimrod uses a long life Lithium cell power soturce that provides the user with extended time usage in dark attics or ceilings. Extensive testing has proven this tool to dramatically reduce time spent in attics and or commercial ceiling applications. The variety of colors the tool comes in allows the user to specify a particular point in an attic so upon entering the attic the point is quickly located by a specific color flashing through the rod. The Kimrod uses Revolutionary phosphorescent wire to illuminate a precise point with flashing colors. The need for a flashlight or other form of light to locate a wire or specific point in a dark spot of an attic or ceiling is no more. The Kimrod offers quick and easy wiring runs to professionals in the industry. This technology offers corporations reduced production cost thus saving labor cost.

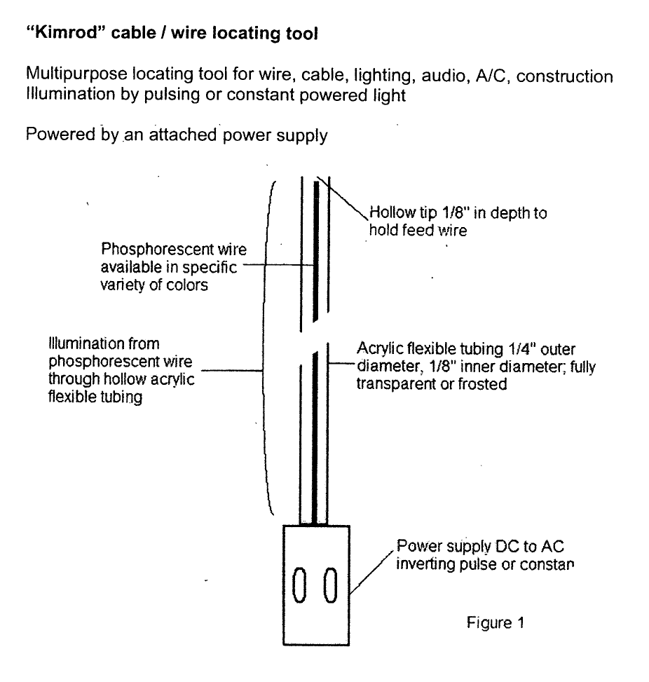

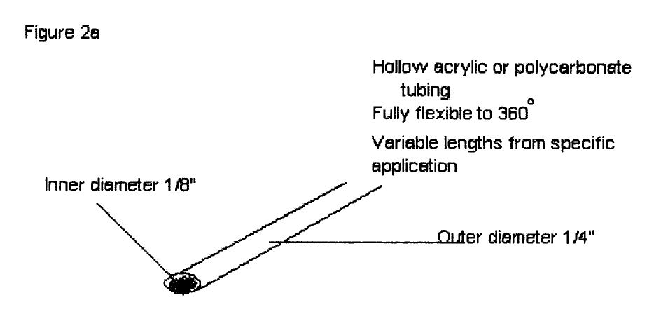

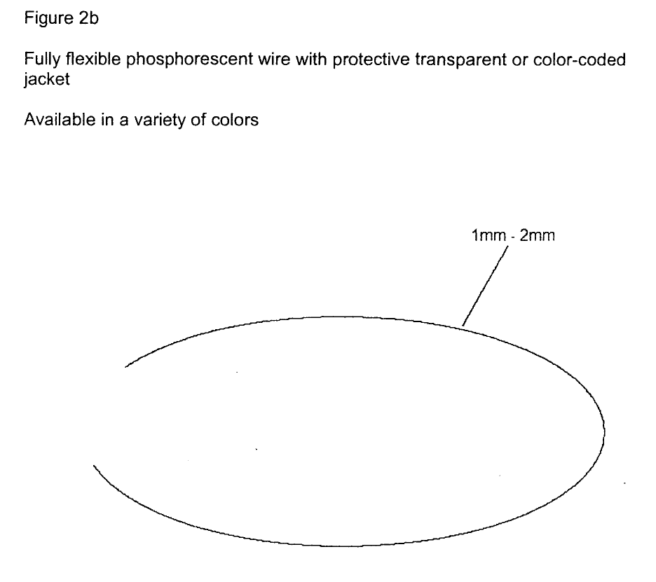

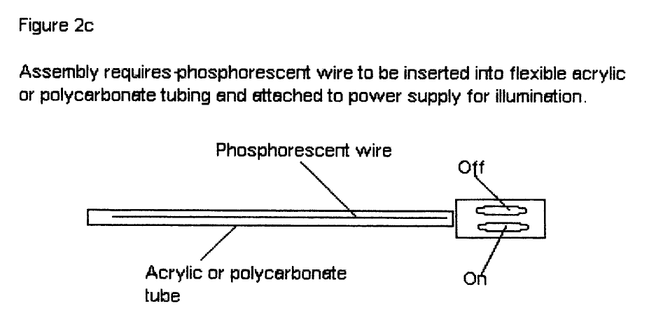

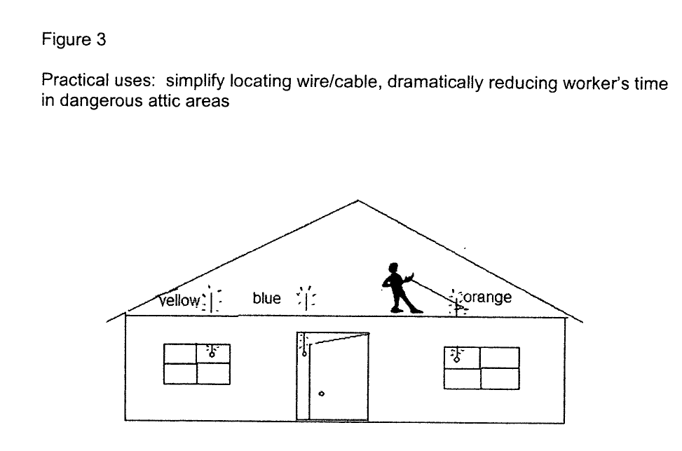

FIGS. 2a,2b, and 2c show the technical disclose of components making up the Kimrod.

1. I hereby claim this tool “the kimrod ”has been designed, and invented solely by me.
